(19) United States
(12) Patent Application Publication
(10) Pub. No.: US 2012/0124458 A1
(43) Pub. Date: May 17, 2012

(54) Social networking website & web-based system for collecting & presenting real-time user generated information on parties & events.

(76) Inventor: Nazareno Brier Cruzada, San Marcos, CA (US)

(21) Appl. No.: 13/217,456

(22) Filed: Aug. 25, 2011

Related U.S. Application Data
(60) Provisional application No. 61/414,590, filed on Nov. 17, 2010.

(51) Int. Cl. G06F 3/00; G06F 17/00; G06F 15/16

(52) U.S. Cl. 715/205; 709/204; 715/238; 715/760

(57) ABSTRACT

This invention is a social networking website & web-based system that allows users to post ‘party reports’—detailed, real-time information about current ongoing parties and events that they know of; allows users to comment and upload pictures & videos on the posted information in real-time; and presents this information in an organized fashion—by city, school or location, by date & time, or by both. The system also contains algorithms used to determine the top or best party cities, schools or locations based on predetermined formulas & user posted information. The website also allows users to connect with other registered users on the website and define them as their ‘peeps’ as well as create ‘crews’, which are close-knit groups of people that they usually party to go out with.

I claim priority of provisional application No. 61/414,590 filed on Nov. 17, 2010 titled “Social networking website & web-based system for collecting & presenting real-time user generated information on parties & events.”

### BACKGROUND OF THE INVENTION

1. Field of the Invention

The World Wide Web has allowed people to post information online and for others to view it, use it, or make comments on it. Social networking websites are quite popular and people spend a good amount of time sharing information & images and interacting with other people online.

2. Description of the Prior Art

Currently, there is no dedicated central ‘party report’ website that allows users to post party or event specific information (i.e. address or location, the number of party-goers, the energy level of the party, dress code, pictures taken in real-time from the specific party of event, etc.) about currently occurring parties and events in real-time, allows users to comment on the posted information in real-time or post their own information or pictures of that particular party or event, and presents this information in an organized fashion (i.e. presenting a list of parties & events currently occurring in a particular city, school, town or location or presenting real-time information or images on a currently occurring party or event.

There are websites such as Zvents.com, 2Night.com, NapkinNights.com, and CoolJunkie.com that allow users to post information about events and present such information in an event calendar and list format. However, these sites cater to commercial entities seeking to advertise in advance, events that they are promoting. As such, posters are allowed to post event information days, weeks or even months in advance. Moreover, these sites are not set up to allow users to report and/or comment on an ongoing party in real-time. As such, these sites don't have party or event specific real-time information such as current number of party-goers, male/female ratio, energy level of the party or event, or comments from other users on how useful or accurate the party report information is.

There are also websites such as SceneTap.com, HeatTrackerApp.com, AssistedSerendipity.com, and WhereTheLadies.at that provide real-time information on the number of people at a particular bar or club as well as the ratio of males to females. However, these sites do not allow people to post party reports in real-time or post other user generated content such as comments, further party details that corroborate or confirm information in the original party report, or uploaded pictures & videos in real-time. Another shortcoming of these sites is that they do not provide other important details about the party or event such as the existence of a line or queue to get in, a more accurate or descriptive male to female ratio rating, if a dress code is enforced, the energy level of the party or event, or a cover charge to get in. These sites also do not provide information that specify the attractiveness, social class, & beauty quality of the party-goers.

Last but not least, these websites do not have functionality to allow users to link to other user profiles on the website & define these other users as their party ‘peeps’ or create ‘crews’, which are close-knit groups of people that they usually go out partying or clubbing with, and to allow users to manage & communicate with their crews.

### SUMMARY OF THE INVENTION

This invention is a ‘party report’ website, database and mobile device application that allows users to post very detailed party or event specific information (i.e. address or location, the number of party-goers, an accurate male-female ratio, the ‘quality level’ of the people in the party, the energy level of the party, dress code, pictures taken in real-time from the party or event, etc.) about currently occurring parties and events in real-time, allows users to comment on the posted information in real-time or post their own information or pictures & videos of that particular party or event, and presents this information to visitors of the website in an organized fashion, i.e. presenting a list of parties & events currently occurring in a particular city, school, town or location or presenting real-time information or images on a currently occurring party or event. When users post comments, the site allows the user to provide further party details that corroborate or confirm information such as number of party-goers, male-female ratio, energy level of the party, and quality level of the party-goers in the original party report. The confirmation of party details from other people or users give added credibility to the original report and is a key element in being a useful website or internet resource.

The website provides functionality that allows the original poster of the party report or users commenting on the report to post a report about an after-party or after-parties and then link the original report to these after-parties.

The website also allows users to connect with other registered users on the website and define them as their ‘peeps’ as well as create ‘crews’, which are close-knit groups of people that they usually party or go out with. The concept of creating/defining ‘peeps’ as well as a ‘crew’ is helpful since a user may have a group of friends in one city that he/she usually goes out with and have another set of friends in another city that he/she goes out with when in that city. Or a user may have a group of friends she goes bar-hopping with and another set of friends she goes to baby showers or play-dates with. A user can then limit the posting or publishing of party information to their ‘peeps’ or a specific ‘crew’ as well as contain back & forth messages within that specific message thread.

To post ‘party reports’, users have to register & create a profile on the site. The use of user generated content to report about parties and to comment or upload pictures on reported parties gives the party report information a higher level of credibility and realism. Furthermore, to gauge the credibility of a user who reported or commented on a party or event, the site uses a rating system based on a formula that takes into consideration the number of party reports the user has previously reported, the number of ‘peeps’ the user has, the rating of the user's previous party reports, as well as the accuracy and usefulness of these reports as noted by other users.

When posting a party or event report on the website, a user can decide whether to make it public or private. If the user chooses to make the party or event private, only the user's ‘peeps’ can view the report. And while the website promotes the posting of currently ongoing parties & events in real-time, the site does provide the ability to allow users to post party or event information in advance but only publish the information publicly once the event is occurring—if the user chooses the event or party to be public. Only a user's ‘peeps’ can view party or event information posted by that user in advance, and if they like it, create a reminder for it in their profile, thereby allowing them to create a personal ‘social calendar’ which is a collection of these reminders shown in calendar format.

### DETAILED DESCRIPTION OF THE INVENTION

The website is composed of several key web pages. These web pages include, but are not limited to:
1. Home page
2. Cities page
3. Party Cities page
4. City page
5. Parties page
6. Top Parties of All-Time page
7. Party page
8. Schools page
9. Party Schools page
10. School page
11. Party People or ‘Peeps’ page
12. Party Person or ‘Peep’ page
13. Register page
14. Logged In User Page
15. User Profile page
16. Update Profile page
17. Post A Party Report page
18. Post a Comment page
19. Add A Calendar Event page
20. User/Personal Social Calendar page
21. Global/Public Social Calendar page
22. Add New Peep page
23. Add New Crew page

The Home page has several key data elements. These data elements include but are not limited to:
1. tabs or links to the other pages mentioned above
2. a list of the top 10 currently ongoing parties around the world
3. a list of the top 10 cities around the world with the best parties
4. a list of the top 10 schools around the world with the best parties
5. a list of the latest party reports from around the world
6. a login form

The list of the top 10 currently ongoing parties around the world is determined by an algorithm that takes into consideration several factors, including the rating that other users have given to the party report, the number of current party-goers, the energy level of the party as reported by people who are at, or have witnessed the party as well as the number of positive comments about the party posted on the website by other users. The list of the top 10 cities around the world with the most parties is determined by an algorithm that takes into consideration several factors, including the number of top currently ongoing parties in each particular city. These two elements of the home page provide a quick view of how festive the world is at the current moment and which locations are the most festive.

The list of the latest party reports from around the world shows in descending chronological order the latest party reports as they get reported on the site. The list of cities around the world shows a list of well known & popular cities around the world, grouped by continent and allows the user to choose a particular city and view the parties & events occurring in that city. The list of schools is similar to the list of cities.

The Home page as well as the Logged In User page will also have the ability to use the IP address of the user viewing the page to determine his or her location and find the closest city or school that is supported on the website or has party reports on the website then tailor and present party or event information based on that location.

The Cities page has a multi-column formatted list showing cities & towns around the world grouped by country & continent. Each city on this list has a hyperlink that when clicked on, redirects the viewer to a City page that shows detailed information about parties and party people in that specific city. The Party Cities page shows the top party cities, towns, & locations in the world at the current moment, as determined by the algorithm used in the home page, in descending order. This page provides a good way to view how festive each location is.

The City page will have several data elements including, but not limited to:
1. a list of the top party reports for that city or town
2. a list of the latest party reports for that city or town
3. a list of the top party people in that city or town

The algorithm used to determine the list of the top party reports for each city is similar to the one used on the home page list, with the addition of a filter for that particular city or town. The list of the top party people in that city or town is determined by an algorithm that takes into consideration several factors, including the number of party reports the user has previously reported & attended as well as the accuracy and usefulness of these reports as noted by other users in points given.

The Parties page shows lists of the currently ongoing parties around the world in descending order based on the same algorithm used on the home page list. A section of the page has a list that shows reports of the hottest parties while another section has a list that shows the latest reports. By default, the page will show lists of the top parties in the world but if a user is logged in, the page can filter the lists to show the top parties for the user's location. Both lists have hyperlinks for each of the reports that when clicked on, redirect the viewer to a Party page that show detailed information about that specific party.

The Party page presents detailed information about a specific party. This information includes, but is not limited to:
1. Party name
2. Description
3. Location or Address
4. City
5. State, Province or Region
6. Country
7. A rating of the party report given by other users
8. Number of current party-goers
9. Ratio of male to female party-goers
10. Rating that defines the quality of the party-goers
11. A list of party-goers currently at the party
12. Energy level at the party
13. Dress code
14. Cover charge (if any)
15. Existence of a line or queue to get in & if yes, how many people in line
16. Party report confirmation type
17. Number of users that found the report useful or true
18. Images from the party uploaded by other users who are/were at the party
19. Comments by other users regarding the party or the party report
20. Button or hyperlink to allow users to post comments on the party
21. Button or hyperlink to allow users to upload pictures or videos of the party
22. A list of after-parties, if any
23. Button or hyperlink to allow users to add party to his/her social calendar
24. Button or hyperlink to allow users to share party info with his/her peeps
25. Button or hyperlink to allow users to post a report on an after-party and link that report to the original party report

The data on the number of party-goers, the energy level of the party, the rating of the report by other users, and the male to female ratio gives people viewing the Party page valuable information that can help decide whether to go to the party. A section with a list of comments by other users regarding the party or the party report has a form that registered users can use to post their own comments. The party report confirmation type is defined by the person posting the party report and the choices include, but are not limited to:
1. Read Flyer—the poster read the flyer for the party
2. Outside Sighting—the poster saw the party from outside
3. In The Party—the poster is/was at the party
4. Produce The Party—the poster is the person throwing the party
5. Heard From Someone—the poster heard about the party from someone

When the user clicks on the button or hyperlink to add the party to his/her social calendar, the user is redirected to the Add A Calendar Event page where the user can confirm all the information and have the option of inviting all of the user's ‘peeps’ or a particular ‘crew’. The user can also choose to not invite anyone and keep the added event private. The Party page also has a button or hyperlink to allow user to directly share party info with his/her peeps without adding the party to his/her social calendar.

The Party page also has a hyperlink that allows the original poster of the party report or other users to post a report about an after-party or after-parties and the website provides functionality that links the original report to these after-parties.

The Schools page has a multi-column formatted list showing schools around the world grouped by country & continent. Each school on this list has a hyperlink that when clicked on, redirects the viewer to a School page that shows detailed information about parties and party people in that specific school. The Party Schools page shows the top party schools in the world at the current moment as determined by an algorithm that takes into consideration several factors, including the number of top currently ongoing parties in each particular school, the number of registered users, the number of top party ‘peeps’ in that school, etc. The schools are listed in descending order, with the top party school listed first.

The School page has several data elements including, but not limited to:
1. a list of the top party reports for that school
2. a list of the latest party reports for that school
3. a list of the top party people in that school

The algorithm used to determine the list of the top party reports for each school is similar to the one used on the home page list, with the addition of a filter for that particular school. The list of the top party people in that school is determined by an algorithm that takes into consideration several factors, including the number of party reports the user has previously reported & attended as well as the accuracy and usefulness of these reports as noted by other users in points given. These points can be given by viewers of a party report when posting a comment on that report using the Post a Comment page.

The Party People or ‘Peeps’ page shows several lists of the top party people in the world or for a particular location, broken down by category such as Top Party Girls, Top Party Guys, Top Party Reporters, Top Party Promoters, Top Party Bloggers, Top Party Crashers, etc. By default, the page will show lists of the top party people in the world but if a user is logged in, the page can filter the lists to show the top party people for the user's location.

The Party Person or ‘Peep’ page presents information about a website user's profile including basic data such as username, age, location, avatar image as well as party related data fields such as number of parties attended, number of party comments posted, number of connected friends, the type of party person the user is (e.g. Rockstar, Social Butterfly, Party Animal, Celebrity, Groupie, Lurker, Hermit, etc.) and the ‘party mode’ that the user is in (e.g. Top Party Form, Life Of The Party, Chillin At The Venue, Looking For A Party, Considering Options, Playing It By Ear, Gearing Up, Ready For Take-Off, Recharging, Winding Down The Night, Having Movie Night, etc.). The Party Person or ‘Peep’ page also shows the user's ‘party gear’ preferences in certain clothing brand names and ‘party favors’ preferences in brand name alcohol. Party gear refers to outfits & accessories that the user wears when going clubbing or going out to parties, from hats to shirts to dresses to shoes. For example, a male user may have the brand names of Armani, Hugo Boss, and Kenneth Cole under the ‘Suits’ section of his ‘Party Gear’ profile while a female user may have Jimmy Choo, Manolo Blahnik & Christian Louboutin under the ‘Shoes’ section of her ‘Party Gear’ profile.

The Logged In User page serves as the user's home page when logged in. This page contains a menu with links to pages that allows the user to see a list of parties, post a party report, view or edit his or her profile, connect with other users on the site to define & add them as ‘peeps’, create ‘crews’, send and receive messages with other registered users, and create and manage a social calendar, among other things. The Logged In User page has the ability to use the IP address of the user viewing the page to determine his or her location and find the closest city or school that is supported on the website or has party reports on the website then tailor and present party or event information based on that location.

The User Profile page is what the logged in user sees when clicking on ‘View Profile’ and is similar to the Party Person or ‘Peep’ page with the addition of the Logged In User page menu being shown.

The Update Profile page allows the user to edit his or her profile information. The page contains text input boxes, drop-down select boxes, and multi-select boxes that allow the user to type in or select from a list. For example, a drop-down select box allows a user to select the particular city or location he or she is currently located at. A multi-select box allows the user to select multiple brand names that a user likes as his or her favorite ‘party gear’. A multi-select box may contain 15-20 of the most popular brand names in shoes and the user can select one or more brand names from the list and then save these selections. Once saved, these selections along with all the other information entered by the user on the page can be shown in the User Profile page as well as be used to present targeted advertisements to the user.

The Post A Party Report page is composed of several key graphical user interface (GUI) elements. On the regular full-sized website, these elements are shown on the same web page, however, on the mobile version of the website, these elements are shown one by one sequentially since they are too big to all fit on the small screen of a mobile device.

The first element is a subscreen with a list of existing party reports. The second element is another subscreen that shows party report details when the user chooses & clicks a party report from the list on the first subscreen. These first & second elements serve the purpose of showing the user existing party reports to help prevent the user from posting another party report on a party that already has a report posted on the website and guides the user to posting comments on an existing report instead. The third element is a subscreen with a form that allows registered users to post a ‘party report’ where he/she can enter party or event information into as well as upload pictures. Party or event information includes, but is not limited to:
1. Party name
2. Description
3. Location or Address
4. City
5. State, Province or Region
6. Country
7. Number of current party-goers
8. Ratio of male to female party-goers
9. Rating that defines the quality of the party-goers
10. Energy level at the party
11. Dress code
12. Cover charge (if any)
13. Existence of a line or queue to get in & if yes, how many people in line
14. Party report confirmation type
15. Images from the party
16. A list of after-parties

The page allows the user who is reporting the party to specify the male to female ratio of the party-goers. This functionality can be a dropdown list control that allows the user to select from several choices such as, but not limited to, percentage based: ‘20% Male-80% Female’, ‘50% Male-50% Female’, ‘90% Male-10% Female’ or numeric based such as ‘1 Male-2 Females’, ‘1 Female-1 Male’, ‘2 Females-1 Male’, etc.

The page also allows the user who is reporting the party to specify the attractiveness, social class, & beauty quality of the party-goers. This functionality can be a dropdown list control that allows the user to select from several choices such as but not limited to: ‘Top Shelf’, ‘Middle Cupboard’, ‘Bottom of the Barrel’, etc.

The party report confirmation type allows the person posting the party report to specify how he or she knows about the party, and the choices include, but are not limited to:
1. Read Flyer—the poster read the flyer for the party
2. Outside Sighting—the poster saw the party from outside
3. In The Party—the poster is/was at the party
4. Produce The Party—the poster is the person throwing the party
5. Heard From Someone—the poster heard about the party from someone

A fourth element in the Post A Party Report page is functionality that uses the information on the submitted party report & searches for a match with existing party reports on data such as Party Name, Party Description, Location or Address, etc. and presents the user with a screen that shows the existing party report and informs the user of a possible match. This screen then gives the user the option to continue on and post his/her original party report or to post a comment on the existing report instead.

Since the website promotes the posting of currently ongoing parties in real-time, the site has the ability to allow users to post party or event information in advance but not publish it publicly until the event is occurring. Only a user's ‘peeps’ can view party or event information posted by that user in advance, and if they like it, create a reminder for it in their profile, thereby allowing them to create a personal ‘social calendar’ which is a collection of these reminders shown in calendar format.

The Post a Comment page has a form that allows a registered user to post a comment on a party report, including updated or corrected information, pictures or videos. The user can use the form on this page to update or correct information from the original party report, including but not limited to: location, number of people in the party, male/female ratio, quality level of the party-goers, energy level of the party, etc. The page also allows the person posting the comment to rate the report by designating or choosing a value on a 5 or 10 point scale, on how valuable the party report is to them.

The Add a Calendar Event page has a form that allows a registered user to add an event to his/her social calendar. The form has fields for event name, description, event location/address, date, and a select box that allows the user to send invites or notices to his/her peeps to the event he/she is adding. The select box has choices to allow the user to send the invites or notices to all his/her peeps or to the peeps of a particular crew that he/she has defined.

The User or Personal Social Calendar page

The Global or Public Social Calendar page

The Add New Peep page allows users to connect with other registered users on the website that they usually party or go out with and define them as their ‘peeps’. The page has a top section with a form that allows the user to search the website's list of registered users by a variety of fields (e.g. Username, Email, First Name, Last Name, etc) for the profile of someone that they socialize, go out or party with. The search then presents a list of users on the web page and allows the logged in user to add users either as a ‘non crew’ peep or to add the user to a particular ‘crew’ via a drop-down select box.

The Add New Crew page allows users to define & create ‘crews’, which are close-knit groups of people that they usually party or go out with. The page has a form that allows the logged in user to enter the name of the new crew they want to create. When the user clicks on the ‘Add New Crew’ button, a record with the name of the new crew is created in the database and linked to the user.

The My Peeps page shows a list of other users that the registered user has chosen & linked up as his/her peeps. The list shows some basic information about the other user such as the user's avatar image, username, which crew the user belongs to (if at all), and party mode. The list also provides hyperlinks that redirect the logged in user to the other user's profile page when the hyperlink is clicked on.

The system provides registered users with alerts when party reports are posted or when an event in their social calendar is approaching. Users can tailor these alerts with filters such as specific cities or schools.

An integral part of the system and the invention is a version of the website designed to be viewed on the smaller screens of mobile devices. This mobile version has smaller versions of the web pages available on the regular site. When the user visits the main website using a browser from a mobile device, the main website has the ability to recognize that the visitor is using a mobile browser and then redirect the visitor to the smaller, mobile version of the website that is tailored for that specific mobile browser.

Another integral part of the system is a version of the website created as a mobile application that can be downloaded and installed on a mobile device or smartphone such as an iPhone or Android phone. This mobile app also has smaller versions of the web pages that are tailored to be viewed from a mobile device.

The main website also has web pages to allow the website owner to administer & manage it, as well as configure the site settings. To provide scalability & performance, the central website utilizes a plurality of load balanced web servers & clustered databases.

What is claimed is:

1. A ‘party report’ website, database, web-based system, and mobile application that:
a) allows users to post party or event specific information (i.e. address or location, the number of party-goers, the energy level of the party, dress code, pictures taken in real-time from the party or event, etc.) about currently occurring parties and events in real-time;
b) allows users to comment on the posted information in real-time or post their own information or pictures of that particular party or event;
c) presents this information in an organized fashion, i.e. presenting a list of parties & events currently occurring in a particular city, school, town or location or presenting real-time information or images on a currently occurring party or event;
d) allows users to connect with other registered users on the website and define them as their ‘peeps’ as well as create ‘crews’, which are close-knit groups of people that they usually party to go out with.

2. A ‘party report’ website that consists of several key web pages. These web pages include, but are not limited to:
1. Home page
2. Cities page
3. Party Cities page
4. City page
5. Parties page
6. Top Parties of All-Time page
7. Party page
8. Schools page
9. Party Schools page
10. School page
11. Party People or ‘Peeps’ page
12. Party Person or ‘Peep’ page
13. Register page
14. Logged In User Page
15. User Profile Page
16. Update Profile page
17. Post A Party Report page
18. Post A Comment page
19. Add A Calendar Event page
20. User/Personal Social Calendar page
21. Global/Public Social Calendar page

3. A version of the website of claim 2 designed to be viewed on the smaller screens of mobile devices. This mobile version has smaller versions of the web pages available on the regular site defined in claim 2. This mobile version will also have web pages that are subscreens created from breaking up & dividing the bigger web pages of the full sized website into smaller elements & sections. When the user visits the main website using a browser from a mobile device, the main website has the ability to recognize that the visitor is using a mobile browser and then redirect the visitor to the smaller, mobile version of the website that is tailored for that specific mobile browser.

4. The mobile application of claim 1 containing smaller versions of the web pages of the website of claim 2 that are tailored to be viewed from a mobile device. This application can be downloaded and installed on a mobile device or smartphone such as an iPhone or Android phone. This mobile application has screens that are smaller versions of the web pages available on the regular site defined in claim 2. It will also have screens that are subscreens created from breaking up & dividing the bigger web pages of the full sized website into smaller elements & sections.

5. The Home page of the website of claim 2 that consists of several key data elements. These data elements include:
1. a list of the top 10 currently ongoing parties around the world
3. a list of the top 10 cities around the world with the best parties
4. a list of the top 10 schools around the world with the best parties
5. a chronologically descending list of the latest party reports from around the world
6. a partial list of cities around the world
8. a partial list of schools around the world

6. A Home page as well as the Logged In User page that has the ability to use the IP address of the user viewing the page to determine his or her location and find the closest city or school that is supported on the website or has party reports on the website then tailor and present party or event information based on that location.

7. A computer algorithm of the website of claim 1 that retrieves user generated party report information from a database and determines the top 10 currently ongoing parties around the world by taking into consideration several data factors, including the number of current party-goers, the energy level of the party as reported by people who are at, or have witnessed the party as well as the number of positive comments about the party posted on the website by other users.

8. A computer algorithm of the website of claim 1 that retrieves user generated party report information from a database and determines the top 10 party cities around the world by taking into consideration several data factors, including the number of top currently ongoing parties in each particular city, the number of current party-goers at each party, the energy level of each party as reported by people who are at, or have witnessed the party as well as the number of positive comments about the party posted on the website by other users.

9. A computer algorithm of the website of claim 1 that retrieves user generated party report information from a database and determines the top 10 party schools around the world by taking into consideration several data factors, including the number of top currently ongoing parties in each particular school, the number of current party-goers at each party, the energy level of each party as reported by people who are at, or have witnessed the party as well as the number of positive comments about the party posted on the website by other users.

10. A Logged In User page of the website of claim 2 that serves as the user's home page when logged in. This page contains a menu with links to pages that allows the user to see a list of parties, post a party report, view or edit his or her profile, link with other users on the site to define & add them as ‘peeps’, create ‘crews’, send and receive messages with other registered users, and create and manage a social calendar, among other things. The Logged In User page has the ability to use the IP address of the user viewing the page to determine his or her location and find the closest city or school that is supported on the website or has party reports on the website then tailor and present party or event information based on that location.

11. A Post A Party Report page of the website of claim 2 that is composed of several key graphical user interface (GUI) elements. The first element is a subscreen with a list of existing party reports. The second element is another subscreen that shows party report details when the user chooses & clicks a party report from the list on the first subscreen. These first & second elements serve the purpose of showing the user existing party reports to help prevent the user from posting another party report on a party that already has a report posted on the website and guides the user to posting comments on an existing report instead. The third element is a subscreen with a form that allows registered users to post a ‘party report’ where he/she can enter party or event information into as well as upload pictures. The fourth element in the Post A Party Report page is functionality that uses the information on the submitted party report & searches for a match with existing party reports on data such as Party Name, Party Description, Location or Address, etc. and presents the user with a screen that shows the existing party report and informs the user of a possible match. This screen then gives the user the option to continue on and post his/her original party report or to post a comment on the existing report instead.

12. Several subscreens shown one by one sequentially that compose the Post A Party Report page of the website of claim 3. The first element is a subscreen with a list of existing party reports. The second element is another subscreen that shows party report details when the user chooses & clicks a party report from the list on the first subscreen. These first & second elements serve the purpose of showing the user existing party reports to help prevent the user from posting another party report on a party that already has a report posted on the website and guides the user to posting comments on an existing report instead. The third element is a subscreen with a form that allows registered users to post a ‘party report’ where he/she can enter party or event information into as well as upload pictures. The fourth element in the Post A Party Report page is functionality that uses the information on the submitted party report & searches for a match with existing party reports on data such as Party Name, Party Description, Location or Address, etc. and presents the user with a screen that shows the existing party report and informs the user of a possible match. This screen then gives the user the option to continue on and post his/her original party report or to post a comment on the existing report instead.

13. A Post A Party Report page of the website of claim 2 that allows registered users to post a ‘party report’ by providing a form that users can enter data into as well as upload pictures. The data elements that can be entered into this web page form include:
1. Party name
2. Party Description
3. the Location or Address of the party
4. the City that the party is located in
5. the State, Province or Region that the party is located in
6. the Country that the party is located in
7. Number of current party-goers
8. Ratio of male to female party-goers
9. Energy level at the party
10. Dress code
11. Cover charge (if any)
12. Party report confirmation type
13. Existence of line or queue to get in & if yes, how many people in line
14. Rating that defines the attractiveness, social class, & beauty quality of party-goers

14. The Post A Party Report page of claim 11 that allows the user who is reporting the party to specify the male to female ratio of the party-goers. This functionality can either be an input box where the user can enter text or a dropdown list control that allows the user to select from several choices such as but not limited to percentage based: ‘20% Male-80% Female’, ‘50% Male-50% Female’, ‘90% Male-10% Female’ or numeric based such as ‘1 Male-2 Females’, ‘1 Female-1 Male’, ‘2 Females-1 Male’, etc.

15. The Post A Party Report page of claim 11 that allows the user who is reporting the party to specify the attractiveness, social class, & beauty quality of the party-goers. This functionality can be a dropdown list control that allows the user to select from several choices such as but not limited to: ‘Top Shelf’, ‘Middle Cupboard’, ‘Bottom of the Barrel’, etc.

16. The Post A Party Report page of claim 11 that allows the user who is reporting the party to specify how he/she came to know about the party—the Party report confirmation type field. This functionality can either be an input box where the user can enter text or a dropdown control that allows the user to select from several choices such as ‘Read Flyer’, ‘Sighting From Outside’, ‘In The Party’, ‘Producing The Party’, or ‘Heard From Someone’.

17. A Parties page of the website of claim 2 that shows lists of the currently ongoing parties around the world in descending order based on the same algorithm used on the home page list. A section of the page has a list that shows reports of the hottest parties while another section has a list that shows the latest reports. By default, the page will show lists of the top parties in the world but if a user is logged in, the page can filter the lists to show the top parties for the user's location. Both lists have hyperlinks for each of the reports that when clicked on, redirect the viewer to a Party page that show detailed information about that specific party.

18. A Party page of the website of claim 2 that presents detailed information about a specific party. This information includes, but is not limited to:
1. Party name
2. Party Description
3. the Location or Address of the party
4. the City that the party is located in
5. the State that the party is located in
6. the Country that the party is located in
7. Number of current party-goers
8. A list of names or online profiles of the party-goers currently at the party
9. Ratio of male to female party-goers
10. Energy level at the party
11. Dress code
12. Cover charge (if any)
13. Existence of line or queue to get in & if yes, how many people in line
14. Party report confirmation type
15. Number of users that found the report useful or true
16. Images from the party uploaded by other users who are/were at the party
17. A list of comments by other users regarding the party or party report
18. The username & profile data of the user who posted the report
19. A form that registered users can use to post their own comments
20. A rating that defines the attractiveness, social class, & beauty quality of the party-goers
21. A list of after-parties
22. A rating of the party report by other users

19. A Post a Comment page of the website of claim 2 that has a form that allows a registered user to post a comment on a party report, including updated or corrected information, pictures or videos. The user can use the form on this page to update or correct information from the original party report, including but not limited to: location, number of people in the party, male/female ratio, quality level of the party-goers, energy level of the party, etc. The page also allows the person posting the comment to rate the report by designating or choosing a value on a 5 or 10 point scale, on how valuable the party report is to them.

20. The Party page of claim 16 that has a hyperlink that allows the original poster of the party report or other users to post a report about an after-party or after-parties and functionality of the website of claim 1 that links the original report to these after-parties.

21. A Party Cities page of the website of claim 2 that shows a list of the top party cities, towns, & locations in the world at the current moment, in descending order, using an algorithm.

22. A Party Schools page of the website of claim 2 that shows a list of the top party schools in the world at the current moment, in descending order, using an algorithm.

23. A Cities page of the website of claim 2 that has a multi-column formatted list showing cities & towns around the world grouped by country & continent.

24. A Schools page of the website of claim 2 that has a multi-column formatted list showing school around the world grouped by country & continent.

25. The website and web-based system of claim 1 that has the ability to allow users to post party or event information in advance but not publish it publicly until the event is occurring. The system will only allow a user's ‘peeps’ to view party or event information posted by that user in advance.

26. The website and web-based system of claim 1 that will only allow user's ‘peeps’ to view party or event information posted by that user in advance, and if they like it, create a reminder for it in their profile, thereby allowing them to create a personal ‘social calendar’ which is a collection of these reminders shown in calendar format.

27. A Party People or ‘Peeps’ page of the website of claim 2 that shows several lists of the top party people in the world or for a particular location, broken down by category such as Top Party Girls, Top Party Guys, Top Party Reporters, Top Party Promoters, Top Party Bloggers, Top Party Crashers, etc. By default, the page will show lists of the top party people in the world but if a user is logged in, the page can filter the lists to show the top party people for the user's location.

28. A Party Person or ‘Peep’ page of the website of claim 2 that presents information about a website user's profile including basic data such as username, age, location, avatar image as well as party related data fields such as number of parties attended, number of party comments posted, number of connected friends or peeps, the type of party person the user is (e.g. Rockstar, Social Butterfly, Party Animal, Celebrity, Groupie, Lurker, Hermit, etc.) and the ‘party mode’ that the user is in (e.g. Top Party Form, Life Of The Party, Playfully Naughty, Socially Interactive, Chillin At The Venue, Looking For A Party, Considering Options, Playing It By Ear, Gearing Up, Ready For Take-Off, In Holding Pattern, Recharging, Winding Down The Night, Enjoying The Morning After, Savoring The Afterglow, Having Movie Night, etc.)

29. The Party Person or ‘Peep’ page of the website of claim 2 that shows the user's ‘party gear’ preferences in certain clothing brand names and ‘party favors’ preferences in brand name alcohol. Party gear refers to outfits & accessories that the user wears when going clubbing or going out to parties, from hats to shirts to dresses to shoes. For example, a male user may have the brand names of Armani, Hugo Boss, and Kenneth Cole under the ‘Suits’ section of his ‘Party Gear’ profile while a female user may have Jimmy Choo, Manolo Blahnik & Christian Louboutin under the ‘Shoes’ section of her ‘Party Gear’ profile.

30. A Logged In User page of the website of claim 2 that serves as the user's home page when logged in. This page contains a menu with links to pages that allows the user to see a list of parties, post a party report, view or edit his or her profile, connect with other users on the site to define & add them as ‘peeps’, create ‘crews’, send and receive messages with other registered users, and create and manage a social calendar, among other things. The Logged In User page has the ability to use the IP address of the user viewing the page to determine his or her location and find the closest city or school that is supported on the website or has party reports on the website then tailor and present party or event information based on that location.

31. An Update Profile page of the website of claim 2 that allows the user to edit his or her profile information. The page contains text input boxes, drop-down select boxes, and multi-select boxes that allow the user to type in or select from a list. For example, a drop-down select box allows a user to select the particular city or location he or she is currently located at. A multi-select box allows the user to select multiple brand names that a user likes as his or her favorite ‘party gear’. A multi-select box may contain 15-20 of the most popular brand names in shoes and the user can select one or more brand names from the list and then save these selections. Once saved, these selections along with all the other information entered by the user on the page can be shown in the User Profile page as well as be used to present targeted advertisements to the user.

32. The website and web-based system of claim 1 that provides registered users with alerts when party reports are posted or when an event in their social calendar is approaching. Users can tailor these alerts with filters such as specific cities or schools.

33. The website and web-based system of claim 1 that is translated into other languages and running in multiple internet domains with various different country extensions (such as .uk, .de, .jp, .br, .ar) to provide for faster, localized content delivery.

34. A Top Parties of All-Time page of the website of claim 2 that shows a list of the top parties in the world since the inception of the website, shown in descending order, using an algorithm.
